(19) United States
(12) Patent Application Publication
(10) Pub. No.: US 2024/0331169 A1
(43) Pub. Date: Oct. 3, 2024

(54) PROCESSING DEVICE, SYSTEM, PROCESSING METHOD, AND APPARATUS

(71) Applicant: CANON KABUSHIKI KAISHA, Tokyo (JP)

(72) Inventors: OSAMU KAWAGUCHI, Kanagawa (JP); JUMPEI ASHIDA, Cupertino, CA (US)

(21) Appl. No.: 18/620,728

(22) Filed: Mar. 28, 2024

(30) Foreign Application Priority Data
Apr. 3, 2023 (JP) 2023-060319

(51) Int. Cl. G06T 7/246; H04N 23/80; H04N 25/47

(52) U.S. Cl. CPC G06T 7/248; H04N 23/80; H04N 25/47

(57) ABSTRACT

A processing device includes a first obtaining circuit configured to obtain first frame data that is frame data of an image of an object at a predetermined interval; a second obtaining circuit configured to obtain event data that is obtainable at an interval shorter than the predetermined interval and is a detection result of a change in a pixel value of the object; and a processor configured to detect motion of the object at an interval shorter than the predetermined interval by using the event data, and generate second frame data from the first frame data and the motion of the object, the second frame data corresponding to a time later than a time to which the first frame data corresponds.

### BACKGROUND

### Technical Field

The aspect of embodiments relates to a processing device, a system, a processing method, and an apparatus.

### Description of the Related Art

There are technologies called cross reality (hereinafter referred to as XR) for combining virtually-generated contents with real world. XR is a general term for virtual reality (hereinafter referred to as VR), augmented reality (hereinafter referred to as AR), mixed reality (hereinafter referred to as MR), substitutional reality (hereinafter referred to as SR), etc., and refers to technologies for combining virtually-generated contents or environment with actual sense or space.

Examples of devices in which XR is used include head-mounted displays (HMDs). HMDs include HMDs in which an optical see-through method is used and HMDs in which a video see-through method is used. The optical see-through method is a method of superposing images displayed on an electronic display on a view visible through a lens with use of an optical system such as a prism or a half mirror. On the other hand, the video see-through method is a method of augmenting the real world by capturing an image of a view in real time with use of a camera installed at the front of an HMD to generate a digital image and compositing the digital image of the view and virtually-generated digital contents.

The video see-through method has a merit in that digital data of an image of a view and digital contents are composited, and therefore, the real world and the digital information are merged at a high level. However, the video see-through method has demerits in that a phenomenon such as VR sickness or visually-induced motion sickness is likely to occur and there arises a difficulty in motion such as catching a moving object with a hand. This is because, in the video see-through method, there is a delay corresponding to the time it takes to perform processing for compositing an image of a view and digital contents between the time when the image of the view is captured and the time when the composited image is displayed. When the video see-through method is used, it is important to display an image of a view that matches the line of sight of a person wearing the HMD on a display without delay.

Japanese Patent Application Publication No. 2014-36357 discloses a technology for suppressing a delay in processing by calculating a motion vector between two frames based on the two frames, and generating a predictive frame from the calculated motion vector.

In the technology disclosed in Japanese Patent Application Publication No. 2014-36357, the motion vector cannot be calculated until the two frames are obtained. Also, the motion vector is calculated at a frequency that is the same as the frame rate. Accordingly, it is not possible to take detailed motion of the object between the two frames into consideration, and predict a future frame with high accuracy. If image capturing is performed at a high frame rate, a difference between time points at which two frames are respectively obtained becomes small and it becomes possible to take detailed motion of the object into consideration, but the processing is to be performed at a high processing speed. Also, the required processing speed cannot be realized when the processing is performed only in a device such as an HMD, and the device cannot be used as a standalone device. Furthermore, a frame is commonly constituted by a large amount of data, and therefore, if image capturing is performed at a high frame rate, communication traffic from an image capturing element (image sensor) such as a CMOS that performs image capturing to a processing device that processes frames increases.

### SUMMARY

A processing device includes: a first obtaining circuit configured to obtain first frame data that is frame data of an image of an object at a predetermined interval; a second obtaining circuit configured to obtain event data that is obtainable at an interval shorter than the predetermined interval and is a detection result of a change in a pixel value of the object; and a processor configured to detect motion of the object at an interval shorter than the predetermined interval by using the event data, and generate second frame data from the first frame data and the motion of the object, the second frame data corresponding to a time later than a time to which the first frame data corresponds.

A system includes: a capturing device; and a display device, wherein the capturing device includes: a first obtaining circuit configured to obtain first frame data that is frame data of an image of an object by capturing the object at a predetermined interval; a second obtaining circuit configured to obtain event data that is obtainable at an interval shorter than the predetermined interval and is a detection result of a change in a pixel value of the object by detecting the change in the pixel value of the object; and a first processor configured to detect motion of the object at an interval shorter than the predetermined interval by using the event data; and a transmission interface configured to transmit the first frame data and motion information regarding the motion of the object to outside of the capturing device, and the display device includes: a receiving interface configured to receive the first frame data and the motion information from outside of the display device; a second processor configured to generate second frame data from the first frame data and the motion information, the second frame data corresponding to a time later than a time to which the first frame data corresponds; and a display configured to display an image based on the second frame data.

A processing method includes: obtaining first frame data that is frame data of an image of an object at a predetermined interval; obtaining event data that is obtainable at an interval shorter than the predetermined interval and is a detection result of a change in a pixel value of the object; detecting motion of the object at an interval shorter than the predetermined interval by using the event data; and generating second frame data from the first frame data and the motion of the object, the second frame data corresponding to a time later than a time to which the first frame data corresponds.

An apparatus includes the above mentioned processing device, and further comprising at least one of: an optical device corresponding to the processing device; a control device configured to control the processing device; a signal processing device configured to process a signal output from the processing device; a display device configured to display information obtained by the processing device; a storage device configured to store information obtained by the processing device; and a mechanical device configured to operate based on information obtained by the processing device.

Further features of the present disclosure will become apparent from the following description of exemplary embodiments with reference to the attached drawings.

### BRIEF DESCRIPTION OF THE DRAWINGS

FIG. 1 is a diagram showing a configuration example of an image capturing device according to Embodiment 1.

FIG. 2 is a diagram showing a configuration example of an event data obtaining unit according to Embodiment 1.

FIG. 3 is a diagram showing a configuration example of a pixel in the event data obtaining unit according to Embodiment 1.

FIG. 4 is a diagram showing a configuration example of a processing unit according to Embodiment 1.

FIG. 5 is a diagram schematically showing processing performed by the processing unit according to Embodiment 1.

FIG. 6 is a diagram showing a configuration example of a processing unit according to Embodiment 2.

FIG. 7 is a diagram schematically showing processing performed by the processing unit according to Embodiment 2.

FIG. 8 is a diagram showing a configuration example of a vision system according to Embodiment 3.

FIG. 9 is a diagram showing a configuration example of an apparatus according to Embodiment 4.

### DESCRIPTION OF THE EMBODIMENTS

The following describes embodiments of the present disclosure with reference to the drawings. Note that the embodiments described below can be combined suitably as long as no contradiction arises.

### Embodiment 1

### Description of Entire Image Capturing Device

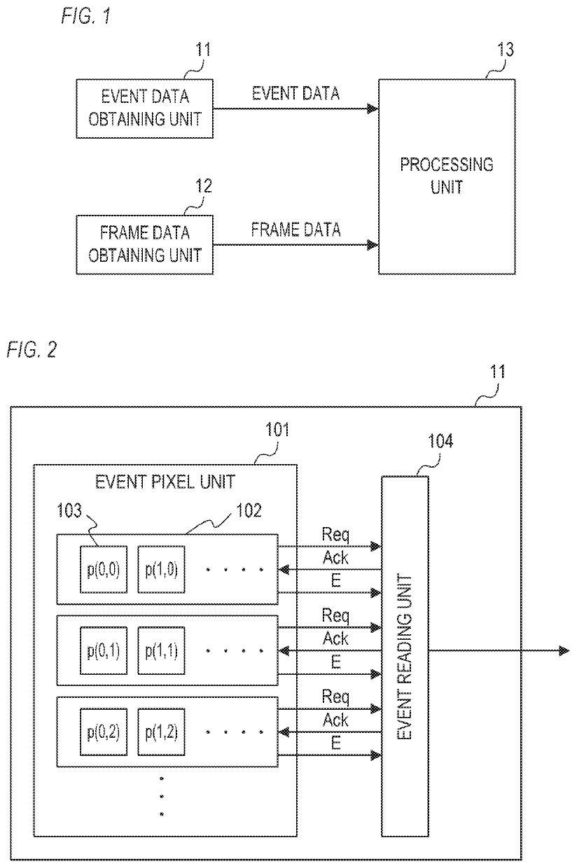

The following describes a configuration of an image capturing device according to Embodiment 1 with reference to FIG. 1. The image capturing device according to Embodiment 1 includes an event data obtaining unit 11, a frame data obtaining unit 12, and a processing unit 13.

The event data obtaining unit 11 is a circuit that detects changes in pixel values of an object and thus obtains event data that is a detection result of a change in the pixel values. The frame data obtaining unit 12 is a circuit that captures images of the object and thus obtains frame data of images of the object. The processing unit 13 (processor) receives event data from the event data obtaining unit 11 and detects motion of the object with use of the event data, and thus obtains motion information that is a detection result of motion of the object. Furthermore, the processing unit 13 generates predictive frame data corresponding to a time later than a time to which frame data output from the frame data obtaining unit 12 corresponds, based on the generated motion information and the frame data output from the frame data obtaining unit 12.

The frame data obtaining unit 12 performs image capturing for obtaining frame data at a predetermined interval (hereinafter referred to as a “frame period”). The event data obtaining unit 11 is capable of detecting changes in the pixel values at an interval shorter than the frame period and obtaining event data at an interval shorter than the frame period. Accordingly, the processing unit 13 is capable of detecting motion of the object at an interval shorter than the frame period by using event data, and capable of obtaining motion information at an interval shorter than the frame period. The processing unit 13 can predict a future frame with high accuracy by using motion information obtained by detecting motion of the object at an interval shorter than the frame period, i.e., at a high time resolution. Specifically, the processing unit 13 can generate predictive frame data in which detailed motion of the object between frames is reflected.

Each of a plurality of images that constitute a video (which may be interpreted as moving image) is a frame. A period from when a frame synchronization signal becomes active to when the frame synchronization signal becomes active again is the period of a single frame, and a single image generated in this period of a single frame is the single frame. An image capturing element (image sensor) commonly includes a plurality of pixels arranged in a two-dimensional array (which may be interpreted as a matrix) and a vertical scanning circuit that scans each row of the plurality of pixels. The frame synchronization signal is a signal for controlling timings at which the vertical scanning circuit starts to operate. When focusing on a pixel row, a period from when signals of the pixel row are read to when signals of the pixel row are read again is the period of a single frame, and a single image generated in this period is the single frame. Frame data is image data of frames.

### Description of Event Data Obtaining Unit

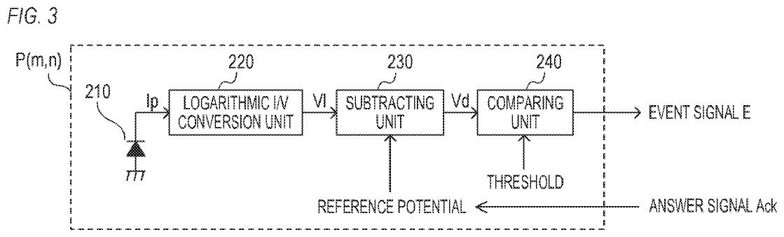

The following describes a circuit configuration of the event data obtaining unit 11 according to Embodiment 1 with reference to FIG. 2. The event data obtaining unit 11 obtains event data by performing a predetermined arithmetic operation on signals detected by pixels. The event data obtaining unit 11 includes an event pixel unit 101 and an event reading unit 104.

Similarly to common image capturing elements, the event pixel unit 101 includes a plurality of pixels P(m, n) 103 arranged in a two-dimensional array. m is an integer satisfying 0≤m≤(M−1), n is an integer satisfying 0≤n≤(N−1), and M×N is the number of pixels included in the event data obtaining unit 11. Note that there is no particular limitation on the arrangement of pixels 103, and it is possible to adopt a one-dimensional line sensor arrangement or any other arrangement.

Each of the plurality of pixels 103 is capable of detecting a change in the quantity of incident light as an event and outputting an event signal E that is a detection result of the change, and is constituted by a circuit shown in FIG. 3, for example. A photodiode 210 generates a photoelectric current Ip corresponding to the quantity of incident light. A logarithmic I/V conversion unit 220 obtains a logarithmic potential Vl by converting the photoelectric current Ip to a potential while performing logarithmic conversion. A subtracting unit 230 calculates a difference Vd between the logarithmic potential Vl and a reference potential. A comparing unit 240 compares the difference Vd with predetermined thresholds. The thresholds include a positive threshold T1 and a negative threshold T2, and if the difference Vd is larger than the positive threshold T1 or smaller than the negative threshold T2, the difference is detected as an event. An event signal E(x, y, t) of a pixel P(x, y) at a time t can be expressed by the following formula.

$$E ( x , y , t ) = \{ \begin{matrix}1 ( when Vd > T 1 ) \\ - 1 ( when Vd < T 2 ) \\ 0 ( otherwise )\end{matrix} \qquad [ Math . 1 ]$$

The resolution of the time tis 1 μs, for example. An event signal E=1 indicates the occurrence of a change in the quantity of incident light that makes the incident light brighter, i.e., the occurrence of a positive event, and an event signal E=−1 indicates the occurrence of a change in the quantity of incident light that makes the incident light darker, i.e., the occurrence of a negative event. The formula shown above is an example expression of the event signal E, and it is possible to adopt various expressions. For example, different numerical values may be respectively assigned to the positive event, the negative event, and a state where no event has occurred. Alternatively, it is also possible to handle event signals indicating the positive event and the negative event as event signals of the same type, without distinguishing between the positive event and the negative event. Events occur at a high time resolution irrespective of (not synchronously with) frame synchronization signals that are used in common image capturing elements. The event signal E is transmitted to the event reading unit 104. The logarithmic potential Vl when an event occurred is used as the next reference potential. The reference potential is updated in response to an answer signal Ack being received from the event reading unit 104.

With respect to each pixel row 102 that is a row of a plurality of pixels 103, the event pixel unit 101 outputs a transmission request signal Req for requesting the event reading unit 104 to transmit event signals E. The transmission request signal Req from each pixel row 102 is output when at least one pixel 103 included in the pixel row 102 has detected an event, i.e., when the event signal E is 1 or −1, for example. Although a case where the event pixel unit 101 outputs the transmission request signal Req with respect to each pixel row 102 has been described, the event pixel unit 101 may also output the transmission request signal Req with respect to each column constituted by a plurality of pixels 103. Alternatively, the event pixel unit 101 may output the transmission request signal Req with respect to another region (pixel group). For example, the transmission request signal Req may also be output with respect to each rectangular region including a predetermined number of columns and a predetermined number of rows.

The event reading unit 104 includes a mediating unit that mediates between transmission request signals Req respectively output from pixel rows 102 of the event pixel unit 101, and reads out the event signal E of each pixel 103 included in a selected pixel row 102. Once the event signals E held by the pixels 103 are read by the event reading unit 104, the event signals E are cleared to 0. Thereafter, an answer signal Ack is transmitted from the event reading unit 104 to the pixel row 102 from which the event signals E have been read, and each pixel 103 included in the pixel row 102 resumes event detection by using a logarithmic potential Vl at the time when the answer signal Ack is received, as a new reference potential.

Each event signal E read by the event reading unit 104 is used as data (event data) that is finally output from the event data obtaining unit 11. For example, the event reading unit 104 outputs event data that includes the polarity of the event (whether the event is a positive event or a negative event), coordinate values corresponding to the event, and time stamp of a point in time at which the event signal E was read. The coordinate values and the time stamp can be obtained by the event reading unit 104. The event reading unit 104 obtains the position of a pixel 103, from which the event signal E was read, in the row direction and the column direction as coordinate values corresponding to the event. Also, the event reading unit 104 includes a timer circuit (not shown), for example, and obtains an output value of the timer at the point in time at which the event signal E was read, as the time stamp.

Note that the event data obtaining unit 11 may be a single-layer sensor or a stacked sensor. In the case where the event data obtaining unit 11 is a stacked sensor, a boundary (Cu-Cu joint) between a first layer and a second layer may be provided in the logarithmic I/V conversion unit 220.

### Description of Frame Data Obtaining Unit

The following describes a configuration of the frame data obtaining unit 12. The frame data obtaining unit 12 is constituted by an image capturing element such as a CMOS, reads electric charges accumulated in photodiodes, performs A/D conversion, and thus obtains frame data.

### Description of Processing Unit

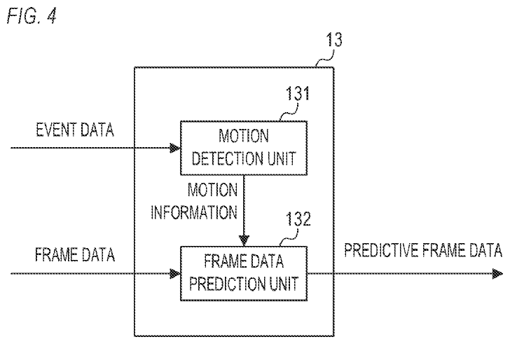

The following describes a configuration of the processing unit 13 according to Embodiment 1 with reference to FIG. 4. The processing unit 13 includes a motion detection unit 131 and a frame data prediction unit 132.

The motion detection unit 131 obtains motion information that is a detection result of motion of the object by using event data output from the event data obtaining unit 11. The motion information indicates the type and amount of motion of the object, for example. Examples of the type of motion include translation in an x direction, translation in a y direction, yawing, pitching, rolling, zooming, etc., and examples of the amount of motion include the speed and acceleration of the motion.

The frame data prediction unit 132 generates predictive frame data from motion information output from the motion detection unit 131 and frame data output from the frame data obtaining unit 12.

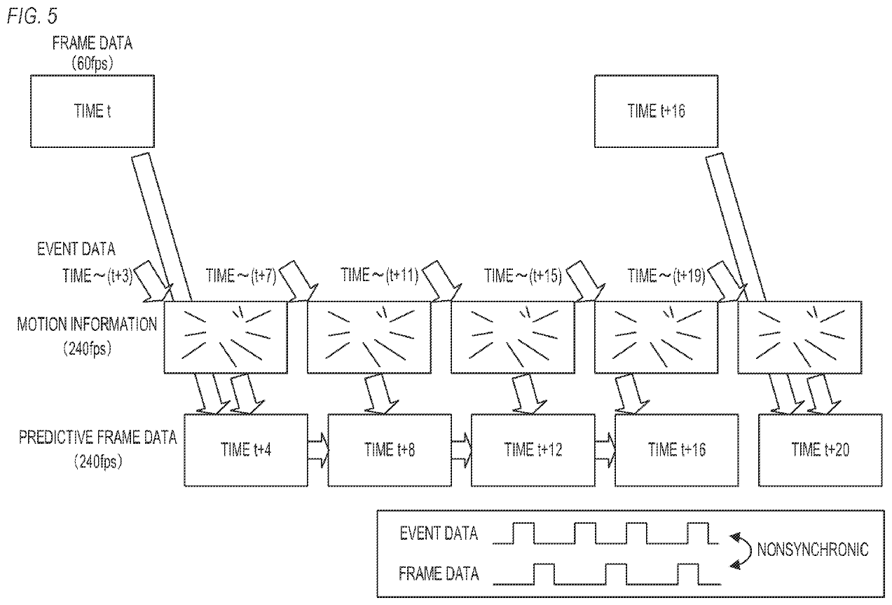

The following describes processing performed by the processing unit 13 with reference to FIG. 5. In FIG. 5, the rightward direction indicates the passage of time. In this example, frame data is output from the frame data obtaining unit 12 at an interval of 60 fps, i.e., about 16.67 msec, but there is no limitation on the rate (frame rate) and the interval (frame period) at which the frame data obtaining unit 12 outputs frame data.

The motion detection unit 131 calculates optical flow by using event data that is output from the event data obtaining unit 11 non-synchronously with frame data output from the frame data obtaining unit 12. The optical flow is vector information representing motion for each pixel or region, and is calculated based on a change in the position at which an event has occurred in a predetermined region in a predetermined period of time, for example. Furthermore, the motion detection unit 131 calculates the type and amount of motion from the optical flow. Known algorithms can be used as a method for calculating the optical flow from event data and a method for calculating the type and amount of motion from the optical flow. Note that there is no particular limitation on the method for calculating (obtaining) the type and amount of motion from event data. For example, it is possible to calculate the type and amount of motion directly from event data without the optical flow being calculated. Any method may be used as the method for calculating the type and amount of motion from event data. In this example, the frame data obtaining unit 12 outputs frame data at a time t. Then, the motion detection unit 131 obtains the type and amount of motion by using event data that is output from the event data obtaining unit 11 at a time t+3 later than the time t, and generates motion information indicating the type and amount of motion. Specifically, the motion detection unit 131 obtains the type and amount of motion by using event data that is output from the event data obtaining unit 11 during a period from the time t to the time t+3, and generates motion information indicating the type and amount of motion. The motion detection unit 131 outputs the generated motion information to the frame data prediction unit 132. Note that optical flow may be used as the motion information.

The frame data prediction unit 132 generates predictive frame data by using the motion information output from the motion detection unit 131 and frame data output from the frame data obtaining unit 12. In this example, the frame data prediction unit 132 generates frame data of a time t+4 as the predictive frame data by using the motion information generated from event data during the period from the time t to the time t+3 and the frame data of the time t. At this point in time, the frame data of the time t+4 is frame data of the future for which image capturing has not been performed.

The motion information output from the motion detection unit 131 indicates motion during the period from the time t to the time t+3, and accordingly, the frame data prediction unit 132 predicts motion during a period to the time t+4 when generating (predicting) the frame data of the time t+4. For example, the frame data prediction unit 132 generates (predicts) motion information indicating motion during a period from the time t to the time t+4 from the motion information indicating motion during the period from the time t to the time t+3. There is no particular limitation on the method for predicting motion information. For example, it is possible to generate, as the motion information indicating motion during the period from the time t to the time t+4, motion information indicating motion that is obtained by multiplying the motion from the time t to the time t+3 by 4/3 with use of the ratio of time (ratio between the lengths of the periods). Then, the frame data prediction unit 132 generates predictive frame data of the time t+4 by using the motion information indicating motion during the period from the time t to the time t+4 and the frame data of the time t.

Note that a known algorithm can be used as a method for predicting frame data of the future from frame data and motion information. Any method may be used as the method for predicting frame data of the future from frame data and motion information. It is also possible to add processing such as filtering processing performed on a boundary between a pixel in which there was motion and a pixel in which there was no motion in order to suppress an artifact at the boundary between those pixels.

Thereafter, the motion detection unit 131 generates motion information from event data during a period from the time t+4 to a time t+7 in a similar manner. Then, the frame data prediction unit 132 generates predictive frame data of a time t+8 by using the motion information generated from event data during the period from the time t+4 to the time t+7 and the predictive frame data of the time t+4. Such processing is repeated until the frame data obtaining unit 12 outputs frame data next to the frame data of the time t. In this example, the frame data obtaining unit 12 outputs frame data next to the frame data of the time t, at a time t+16.

The following describes processing performed by the processing unit 13 when the frame data obtaining unit 12 has output frame data of the time t+16, i.e., the frame data next to the frame data of the time t. The motion detection unit 131 generates motion information from event data during a period from the time t+16 to a time t+19 and outputs the generated motion information to the frame data prediction unit 132. The frame data prediction unit 132 generates predictive frame data of a time t+20 by using the motion information generated from event data during the period from the time t+16 to a time t+19 and the frame data output from the frame data obtaining unit 12 at the time t+16.

As described above, according to Embodiment 1, it is possible to detect motion of the object at an interval shorter than the frame period by using event data. Also, it is possible to predict a future frame with high accuracy by using motion of the object detected at the interval shorter than the frame period, i.e., detected at a high time resolution.

Although an example in which the event data obtaining unit 11 and the frame data obtaining unit 12 are used as two sensors has been described, it is also possible to use a single hybrid sensor that is capable of obtaining both event data and frame data.

Also, an example in which an image processing device that generates predictive frame data is an image capturing device has been described, but the image processing device that generates predictive frame data need not be an image capturing device. For example, a configuration is also possible in which an image processing device separate from an image capturing device obtains event data and frame data from the image capturing device, detects motion of the object by using the event data, and generates predictive frame data from the frame data and motion of the object.

### Embodiment 2

In the example described in Embodiment 1, frame data of the future is predicted with use of frame data and motion information generated from event data. In Embodiment 2, an example will be described in which intermediate frame data is generated from predictive frame data generated with use of the method described in Embodiment 1 and frame data that is obtained through image capturing (hereinafter referred to as “captured frame data”), in order to suppress an artifact that occurs when prediction was wrong. Examples of an artifact that occurs when prediction was wrong include distortion of the shape of an object in an image and a difference of motion of an object in an image from actual motion. Although the intermediate frame data is one type of predictive frame data, hereinafter, only predictive frame data generated with use of the method described in Embodiment 1 will be referred to as “predictive frame data” to distinguish between predictive frame data generated with use of the method described in Embodiment 1 and the intermediate frame data.

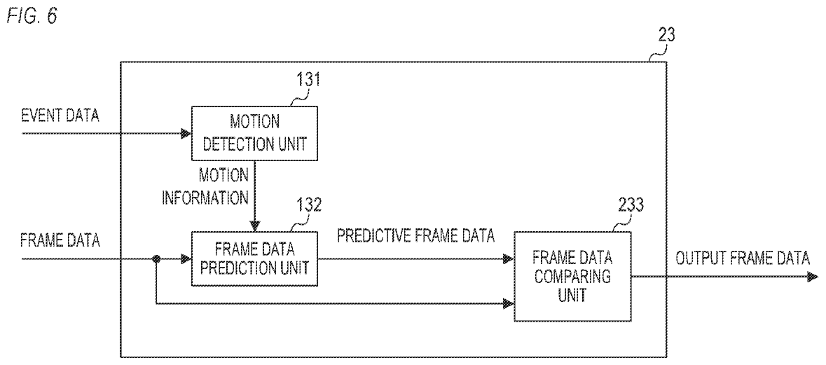

In Embodiment 2, the processing unit 13 shown in FIG. 4 is not used, and a processing unit 23 shown in FIG. 6 is used. The processing unit 23 includes a motion detection unit 131, a frame data prediction unit 132, and a frame data comparing unit 233. Processing performed by the motion detection unit 131 and the frame data prediction unit 132 of the processing unit 23 is the same as that described in Embodiment 1, and therefore, descriptions thereof are omitted.

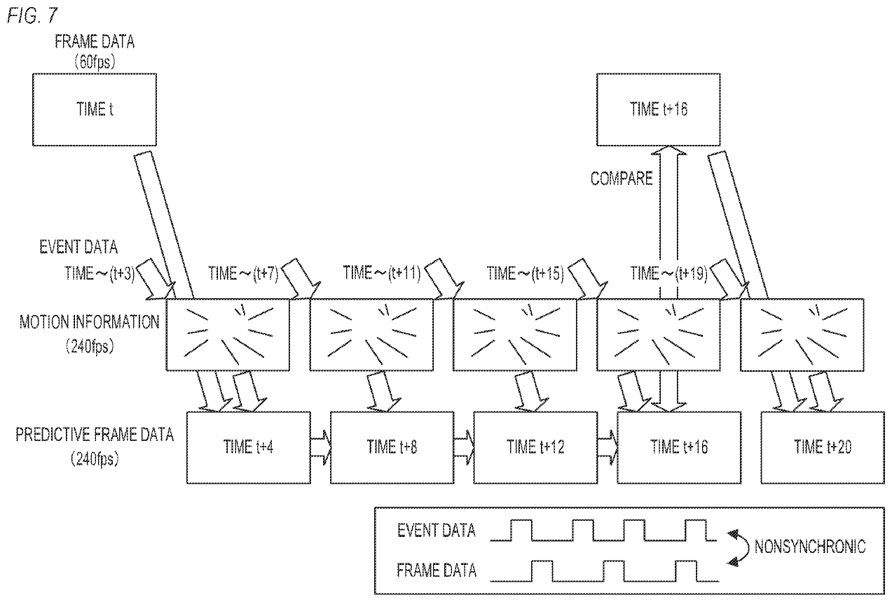

The following describes operations of the frame data comparing unit 233 with reference to FIG. 7. The frame data comparing unit 233 compares captured frame data that is output from the frame data obtaining unit 12 and predictive frame data that is output from the frame data prediction unit 132, and determines whether or not a difference between the captured frame data and the predictive frame data is larger than a threshold.

For example, the frame data comparing unit 233 compares captured frame data and predictive frame data corresponding to a time that is the closest to a time corresponding to the captured frame data. In this example, the frame data comparing unit 233 compares captured frame data and predictive frame data that correspond to the same time. Specifically, the frame data comparing unit 233 compares captured frame data of the time t+16 and predictive frame data of the time t+16. In this comparison, the frame data comparing unit 233 calculates a difference between a value included in the captured frame data and a value included in the predictive frame data with respect to each pixel, and calculates an integrated value of differences calculated for all pixels, as a difference between the captured frame data and the predictive frame data.

When the integrated value is larger than the threshold, prediction of the frame data was wrong. When an integrated value that is a difference between the captured frame data of the time t+16 and the predictive frame data of the time t+16 is larger than the threshold, an image corresponding to the predictive frame data of the time t+16 does not smoothly transition to an image corresponding to predictive frame data of the time t+20. Therefore, when the integrated value is larger than the threshold, the frame data comparing unit 233 generates intermediate frame data and outputs the intermediate frame data. When the integrated value that is a difference between the captured frame data of the time t+16 and the predictive frame data of the time t+16 is larger than the threshold, intermediate frame data of the time t+16 is generated from the captured frame data of the time t+16 and the predictive frame data of the time t+16. When the integrated value is equal to or smaller than the threshold, the frame data comparing unit 233 outputs the predictive frame data generated by the frame data prediction unit 132. When the integrated value that is a difference between the captured frame data of the time t+16 and the predictive frame data of the time t+16 is equal to or smaller than the threshold, the predictive frame data of the time t+16 is output.

For example, the frame data comparing unit 233 generates, as intermediate frame data, frame data that has a value (e.g., an average value) between the value included in the captured frame data and the value included in the predictive frame data with respect to each pixel. The intermediate frame data may have a value between the value included in the captured frame data and the value included in the predictive frame data with respect to the whole region of the object (which may be read as an image), but this configuration does not need to be adopted. For example, a configuration is also possible in which, among pieces of data constituting the intermediate frame data, only a piece of data that corresponds to a part of a region of the object (e.g., a region in which there is a large difference between the captured frame data and the predictive frame data) has a value between the value included in the captured frame data and the value included in the predictive frame data. In this case, among the pieces of data constituting the intermediate frame data, each piece of data corresponding to the remaining region of the object may have the same value as the value included in the captured frame data or the value included in the predictive frame data. Among pieces of data constituting the captured frame data, a piece of data that is used to obtain a piece of data corresponding to a part (hereinafter referred to as a “partial region”) of a region of the object in the intermediate frame data may correspond to a region that is at the same location as the partial region, but this configuration does not need to be adopted. Likewise, among pieces of data constituting the predictive frame data, a piece of data that is used to obtain the piece of data corresponding to the partial region in the intermediate frame data may correspond to a region that is at the same location as the partial region, but this configuration does not need to be adopted. The piece of data corresponding to the partial region in the intermediate frame data may be obtained with use of a piece of data included in the captured frame data and a piece of data included in the predictive frame data, which pieces of data respectively correspond to regions that are at different locations.

In a case where the intermediate frame data is displayed, a delay corresponding to the time it takes to perform the processing for generating the intermediate frame data occurs in displaying the frame data, when compared with a case where predictive frame data is displayed. However, such a delay is short enough to be negligible and is not an issue.

The processing performed by the frame data comparing unit 233 may be performed with respect to all captured frame data output from the frame data obtaining unit 12 or may be performed only with respect to some of the captured frame data. For example, the processing may be performed at a frequency of once every several frames. Whether or not to perform the processing may be switched depending on the complexity of captured frame data. There is no particular limitation on the method for calculating the complexity of captured frame data. For example, the complexity of captured frame data can be calculated based on an integrated value of differences between an average pixel value of the captured frame data and each pixel value. The complexity of captured frame data can also be calculated based on the complexity of motion detected from event data.

As described above, according to Embodiment 2, when prediction of frame data was wrong, intermediate frame data is generated, and therefore, it is possible to realize smooth transition of images even in such a case.

### Embodiment 3

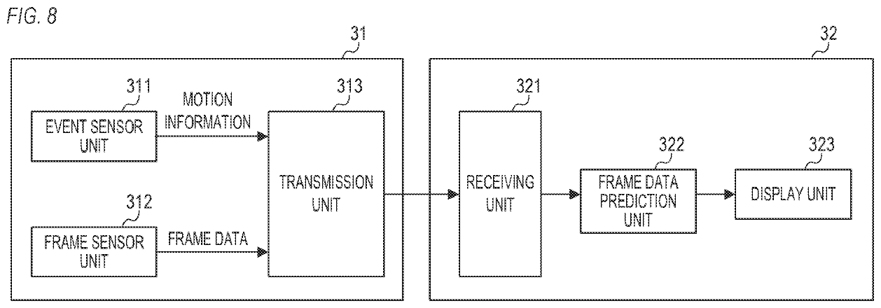

In Embodiment 3, an example of a system in which an image capturing device and a display device are used will be described. The following describes a configuration of a vision system according to Embodiment 3 with reference to FIG. 8. The vision system according to Embodiment 3 includes an image capturing device 31 and a display device 32.

The image capturing device 31 includes an event sensor unit 311, a frame sensor unit 312, and a transmission unit 313. The event sensor unit 311 has the functions of the event data obtaining unit 11 and the motion detection unit 131 in Embodiment 1. Processing performed by the frame sensor unit 312 is the same as the processing performed by the frame data obtaining unit 12 in Embodiment 1. The transmission unit 313 (transmission (communication) interface) receives motion information output from the event sensor unit 311 and frame data output from the frame sensor unit 312, and transmits the motion information and the frame data to the outside of the image capturing device 31.

The display device 32 includes a receiving unit 321, a frame data prediction unit 322, and a display unit 323. The receiving unit 321 (reception (communication) interface) receives the frame data and the motion information output from the transmission unit 313 of the image capturing device 31, from the outside of the display device 32, and outputs the received frame data and motion information to the frame data prediction unit 322. Processing performed by the frame data prediction unit 322 is the same as the processing performed by the frame data prediction unit 132 in Embodiment 1. The frame data prediction unit 322 generates predictive frame data by using the motion information and the frame data output from the receiving unit 321 and outputs the generated predictive frame data to the display unit 323. The display unit 323 displays an image based on the predictive frame data output from the frame data prediction unit 322.

As described above, according to Embodiment 3, it is possible to predict future frames with high accuracy similarly to Embodiment 1. Furthermore, the image capturing device 31 transmits motion information and frame data, and the display device 32 generates predictive frame data by using the motion information and the frame data. With this configuration, it is possible to reduce communication traffic between the image capturing device 31 and the display device 32 when compared with a case where predictive frame data is sequentially transmitted from the image capturing device 31 to the display device 32.

Although an example in which the image capturing device 31 generates motion information has been described, the device that generates the motion information does not need to be the image capturing device 31. For example, a configuration is also possible in which event data is transmitted from the image capturing device 31 to the display device 32, and motion information is generated from the event data by the display device 32. With this configuration as well, it is possible to reduce communication traffic between the image capturing device 31 and the display device 32 when compared with a case where predictive frame data is sequentially transmitted from the image capturing device 31 to the display device 32.

### Embodiment 4

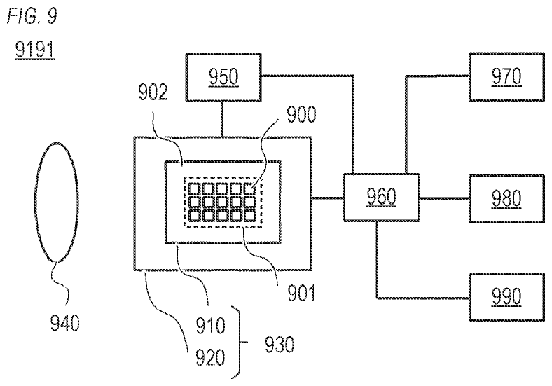

Both Embodiments 1 and 2 can be applied to Embodiment 4. FIG. 9 is a schematic diagram showing an apparatus 9191 including a semiconductor device 930 according to the present embodiment. The semiconductor device 930 can be constituted by either one of the image capturing devices (image processing devices) described in Embodiments 1 and 2 or an image capturing device (image processing device) obtained by combining a plurality of embodiments. The following describes the apparatus 9191 including the semiconductor device 930 in detail. The semiconductor device 930 may include a semiconductor device 910 including a semiconductor layer as described above, and a package 920 for housing the semiconductor device 910. The package 920 may include a substrate to which the semiconductor device 910 is fixed and a cover made of glass or the like and facing the semiconductor device 910. The package 920 may further include a joining member such as a bonding wire or a bump for connecting a terminal provided on the substrate and a terminal provided on the semiconductor device 910.

The apparatus 9191 may include at least any of an optical device 940, a control device 950, a processing device 960, a display device 970, a storage device 980, and a mechanical device 990. The optical device 940 corresponds to the semiconductor device 930. Examples of the optical device 940 include a lens, a shutter, and a mirror. The control device 950 controls the semiconductor device 930. The control device 950 is a semiconductor device such as an ASIC.

The processing device 960 processes signals output from the semiconductor device 930. The processing device 960 is a semiconductor device such as a CPU or an ASIC for constituting an AFE (Analog Front End) or a DFE (Digital Front End). The display device 970 is an EL display device or a liquid crystal display device that displays information (image) obtained by the semiconductor device 930. The storage device 980 is a magnetic device or a semiconductor device for storing information (image) obtained by the semiconductor device 930. The storage device 980 is a volatile memory such as SRAM or DRAM, or a non-volatile memory such as a flash memory or a hard disk drive.

The mechanical device 990 includes a movable unit or a driving unit such as a motor and an engine. In the apparatus 9191, signals output from the semiconductor device 930 are displayed in the display device 970 or transmitted to the outside via a communication device (not shown) included in the apparatus 9191. Therefore, in one embodiment, the apparatus 9191 further includes the storage device 980 and the processing device 960 in addition to a storage circuit and an arithmetic operation circuit included in the semiconductor device 930. The mechanical device 990 may be controlled based on signals output from the semiconductor device 930.

The apparatus 9191 is suitable for an electronic apparatus such as an information terminal (e.g., a smartphone or a wearable terminal) that has an image capturing function or a camera (e.g., a lens-replaceable camera, a compact camera, a video camera, or a monitoring camera). The mechanical device 990 included in a camera can drive components of the optical device 940 for zooming, focusing, and a shutter operation. Alternatively, the mechanical device 990 included in a camera can move the semiconductor device 930 for a vibration reducing operation.

The apparatus 9191 may also be a transportation apparatus such as a vehicle, a ship, or a flying object. The mechanical device 990 included in a transportation apparatus may be used as a travel device. The apparatus 9191 is suitable for a transportation apparatus that transports the semiconductor device 930 or in which an image capturing function is utilized to assist and/or automate driving (piloting). The processing device 960 used to assist and/or automate driving (piloting) can perform processing for operating the mechanical device 990, which serves as a travel device, based on information obtained by the semiconductor device 930. Alternatively, the apparatus 9191 may be a medical apparatus such as an endoscope, a measurement apparatus such as a distant measurement sensor, an analysis apparatus such as an electron microscope, an office apparatus such as a copying machine, or an industrial apparatus such as a robot.

According to Embodiment 4 described above, it is possible to obtain favorable pixel characteristics. Accordingly, it is possible to increase the value of the semiconductor device 930. Here, increasing the value means at least any of adding a function, improving performance, improving characteristics, improving reliability, increasing the production yield, reducing an environmental load, reducing cost, downsizing, and reducing the weight.

Accordingly, by using the semiconductor device 930 according to Embodiment 4 in the apparatus 9191, it is possible to increase the value of the apparatus as well. For example, when the semiconductor device 930 is installed in a transportation apparatus, it is possible to obtain excellent performance when capturing images of the outside of the transportation apparatus or measuring the external environment. Therefore, determining to install the semiconductor device 930 according to Embodiment 4 in a transportation apparatus when manufacturing or selling the transportation apparatus is beneficial in increasing the performance of the transportation apparatus itself. In particular, the semiconductor device 930 is suitable for a transportation apparatus in which driving of the transportation apparatus is assisted and/or automated with use of information obtained by the semiconductor device 930.

Each embodiment described above can be modified as appropriate within a scope not departing from the technical idea. Note that contents disclosed in the present specification include not only those described in the present specification but also all matters that can be grasped from the present specification and the drawings attached to the present specification. Also, the contents disclosed in the present specification encompass a complementary set of the concepts described in the present specification. For example, when the present specification includes a description “A is larger than B”, it can be said that the present specification discloses “A is not larger than B” even when the description “A is not larger than B” is omitted. This is because the description “A is larger than B” is made with consideration given to the case where “A is not larger than B”.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-060319, filed on Apr. 3, 2023, which is hereby incorporated by reference herein in its entirety.

What is claimed is:

1. A processing device comprising:
a first obtaining circuit configured to obtain first frame data that is frame data of an image of an object at a predetermined interval;
a second obtaining circuit configured to obtain event data that is obtainable at an interval shorter than the predetermined interval and is a detection result of a change in a pixel value of the object; and
a processor configured to detect motion of the object at an interval shorter than the predetermined interval by using the event data, and generate second frame data from the first frame data and the motion of the object, the second frame data corresponding to a time later than a time to which the first frame data corresponds.

2. The processing device according to claim 1,
wherein the first obtaining circuit captures the object at the predetermined interval, and
the second obtaining circuit detects the change in the pixel value.

3. The processing device according to claim 1,
wherein the processor generates the second frame data based on the first frame data and the motion of the object detected by using the event data corresponding to the time later than the time to which the first frame data corresponds.

4. The processing device according to claim 1,
wherein the processor further generates, in a case where a difference between the first frame data and the second frame data is larger than a threshold, third frame data by using third data that has a value between first data and second data, the first data corresponding to at least part of a region of the object in the first frame data, and the second data corresponding to at least part of a region of the object in the second frame data.

5. The processing device according to claim 4,
wherein the value of the third data is an average value between a value of the first data and a value of the second data.

6. The processing device according to claim 1,
wherein the processor further generates, in a case where a difference between the first frame data and the second frame data is larger than a threshold, third frame data by using third data that has a value between first data and second data, the first data corresponding to a part of a region of the object in the first frame data, and the second data corresponding to the part of a region of the object in the second frame data.

7. The processing device according to claim 6,
wherein the value of the third data is an average value between a value of the first data and a value of the second data.

8. An apparatus comprising the processing device according to claim 1, and further comprising at least one of:
an optical device corresponding to the processing device;
a control device configured to control the processing device;
a signal processing device configured to process a signal output from the processing device;
a display device configured to display information obtained by the processing device;
a storage device configured to store information obtained by the processing device; and
a mechanical device configured to operate based on information obtained by the processing device.

9. A system comprising:
a capturing device; and
a display device,
wherein the capturing device includes:
a first obtaining circuit configured to obtain first frame data that is frame data of an image of an object by capturing the object at a predetermined interval;
a second obtaining circuit configured to obtain event data that is obtainable at an interval shorter than the predetermined interval and is a detection result of a change in a pixel value of the object by detecting the change in the pixel value of the object; and
a first processor configured to detect motion of the object at an interval shorter than the predetermined interval by using the event data; and
a transmission interface configured to transmit the first frame data and motion information regarding the motion of the object to outside of the capturing device, and
the display device includes:
a receiving interface configured to receive the first frame data and the motion information from outside of the display device;
a second processor configured to generate second frame data from the first frame data and the motion information, the second frame data corresponding to a time later than a time to which the first frame data corresponds; and
a display configured to display an image based on the second frame data.

10. A processing method comprising:
obtaining first frame data that is frame data of an image of an object at a predetermined interval;
obtaining event data that is obtainable at an interval shorter than the predetermined interval and is a detection result of a change in a pixel value of the object;
detecting motion of the object at an interval shorter than the predetermined interval by using the event data; and
generating second frame data from the first frame data and the motion of the object, the second frame data corresponding to a time later than a time to which the first frame data corresponds.

11. The processing method according to claim 10, further comprising:
capturing the object at the predetermined interval, and
detecting the change in the pixel value.

12. The processing method according to claim 10, further comprising:
generating the second frame data based on the first frame data and the motion of
the object detected by using the event data corresponding to the time later than the time to which the first frame data corresponds.

13. The processing method according to claim 10, further comprising:
generating, in a case where a difference between the first frame data and the second frame data is larger than a threshold, third frame data by using third data that has a value between first data and second data, the first data corresponding to at least part of a region of the object in the first frame data, and the second data corresponding to at least part of a region of the object in the second frame data.

14. The processing method according to claim 13,
wherein the value of the third data is an average value between a value of the first data and a value of the second data.

15. The processing method according to claim 10, further comprising:
generating, in a case where a difference between the first frame data and the second frame data is larger than a threshold, third frame data by using third data that has a value between first data and second data, the first data corresponding to a part of a region of the object in the first frame data, and the second data corresponding to the part of a region of the object in the second frame data.

16. The processing method according to claim 15,
wherein the value of the third data is an average value between a value of the first data and a value of the second data.
